(19) United States
(12) Patent Application Publication
(10) Pub. No.: US 2023/0036366 A1
(43) Pub. Date: Feb. 2, 2023

(54) IMAGE ATTRIBUTE CLASSIFICATION METHOD, APPARATUS, ELECTRONIC DEVICE, MEDIUM AND PROGRAM PRODUCT

(71) Applicant: LEMON INC., Grand Cayman (KY)

(72) Inventors: Jingna SUN, Beijing (CN); Weihong ZENG, Beijing (CN); Peibin CHEN, Beijing (CN); Xu WANG, Beijing (CN); Shen SANG, Los Angeles, CA (US); Jing LIU, Los Angeles, CA (US); Chunpong LAI, Los Angeles, CA (US)

(21) Appl. No.: 17/538,938

(22) Filed: Nov. 30, 2021

(30) Foreign Application Priority Data
Jul. 30, 2021 (CN) 202110870599.4

(51) Int. Cl. G06V 40/16; G06V 10/82; G06N 3/04

(52) U.S. Cl. CPC G06V 40/171; G06V 40/172; G06V 10/82; G06N 3/04; G06V 40/197

(57) ABSTRACT

The present disclosure relates to an image attribute classification method, apparatus, electronic device, medium, and program product. The present disclosure enables inputting the image to a feature extraction network to obtain a feature map after feature extraction and N times down-sampling, wherein at least one attribute of the image occupies a second rectangular position area in the feature map after N times down-sampling; calculating a mask function of the at least one attribute of the feature map after N times down-sampling based on the second rectangular position area; obtaining a feature corresponding to the at least one attribute by dot multiplying the feature map after N times down-sampling with the mask function; and inputting the obtained feature corresponding to the at least one attribute to the corresponding attribute classifier for attribute classification.

### CROSS-REFERENCE TO RELATED APPLICATIONS

This application is based on and claims priority of CN application with application No. 202110870599.4 filed on Jul. 30, 2021, the entire disclosure of which is hereby incorporated by reference in its entirety.

### TECHNICAL FIELD

The present disclosure relates to the field of image processing, and in particular, to an image attribute classification method, apparatus, electronic device, medium, and program product based on area selection.

### BACKGROUND

Face attribute analysis is a current research hotspot. A plurality of attributes of a face can be obtained through face images, including eye shape, eyebrow shape, nose shape, mouth shape, face type, hairstyle, the beard type, as well as jewelry wearing condition, including whether or not wearing glasses, a mask, a hat, etc.

The related technology mainly trains one convolutional neural network for each attribute respectively for classification, and therefore has a corresponding proprietary classification model for each attribute. The disadvantage of this technology is that a model is developed for each attribute, the number of models is too large, the storage space is large, and the amount of calculation to obtain all attributes is also large.

Therefore, an attribute classification method that can balance the number of classification models and the amount of calculation is needed.

### SUMMARY

The section of the SUMMARY is provided to introduce concepts in a brief form, and these concepts will be described in detail in following section of DETAILED DESCRIPTIONS. The section of the SUMMARY is not intended to identify key features or essential features of the technical solution claimed, nor is it intended to limit the scope of the technical solution claimed.

According to some embodiments of the present disclosure, there is provided an image attribute classification method, comprising: inputting the image to a feature extraction network to obtain a feature map after feature extraction and N times down-sampling, wherein at least one attribute of the image occupies a second rectangular position area in the feature map after N times down-sampling; based on the second rectangular position area, calculating a mask function of the at least one attribute of the feature map after N times down-sampling; obtaining a feature corresponding to the at least one attribute by dot multiplying the feature map after N times down-sampling with the mask function; and inputting the obtained feature corresponding to the at least one attribute to the corresponding attribute classifier for attribute classification.

According to some embodiments of the present disclosure, there is provided an image attribute classification apparatus, comprising: a feature map acquisition unit configured to input the image to a feature extraction network to obtain a feature map after feature extraction and N times down-sampling, wherein at least one attribute of the image occupies a second rectangular position area in the feature map after N times down-sampling; a mask function calculation unit configured to, based on the second rectangular position area, calculate a mask function of the at least one attribute of the feature map after N times down-sampling; a dot multiplier configured to obtain a feature corresponding to the at least one attribute by dot multiplying the feature map after N times down-sampling with the mask function; and an attribute classification unit configured to input the obtained feature corresponding to the at least one attribute to the corresponding attribute classifier for attribute classification.

According to some embodiments of the present disclosure, there is provided an electronic device, comprising: a memory; and a processor coupled to the memory, the processor being configured to execute the method of any embodiment in the present disclosure based on instructions stored in the memory.

According to some embodiments of the present disclosure, there is provided a computer-readable storage medium having computer programs stored thereon, which, when executed by a processor, executes the method of any embodiment in the present disclosure.

According to some embodiments of the present disclosure, there is provided a computer program product including computer programs, which, when executed by a processor, executes the method of any embodiment in the present disclosure.

Through the following detailed description of exemplary embodiments of the present disclosure with reference to the accompanying drawings, other features, aspects and advantages of the present disclosure will become apparent.

### BRIEF DESCRIPTION OF THE DRAWINGS

Hereinafter, some embodiments of the present disclosure will be described with reference to the drawings. The drawings described here are used to provide a further understanding of the present disclosure, and each of drawings along with following detailed description are included in and forms a part of the specification for explaining the present disclosure. It should be understood that the drawings in the following description only relate to some embodiments of the present disclosure, and do not constitute a limitation to the present disclosure. In the drawings:

FIG. 1 shows an image attribute classification method based on area selection according to some embodiments of the present disclosure.

FIG. 2 shows a schematic diagram of 96 landmarks of a human face according to some embodiments of the present disclosure.

FIG. 3 shows a block diagram of face attribute classification based on area selection according to an exemplary embodiment of the present disclosure.

FIG. 4 shows a block diagram of some embodiments of an electronic device of the present disclosure.

FIG. 5 shows a block diagram of an example structure of a computer system that can be adopted in some embodiments of the present disclosure.

FIG. 6 is a schematic structural diagram of an image attribute classification apparatus according to some embodiments of the present disclosure.

It should be understood that, for ease of description, the sizes of various parts shown in the drawings are not necessarily drawn in accordance with actual proportional relationships. The same or similar reference numerals are used in each of drawings to denote the same or similar components. Therefore, once an item is defined in one drawing, it may not be discussed further in subsequent drawings.

### DETAILED DESCRIPTION

The technical solutions in the embodiments of the present disclosure will be clearly and completely described below in conjunction with the accompanying drawings in the embodiments of the present disclosure. However, it is apparent that the described embodiments are only a part of embodiments of the present disclosure, rather than all embodiments. The following description of embodiments is actually only illustrative, and in no way serves as any limitation to the present disclosure and its application or usage. It should be understood that the present disclosure can be implemented in various forms, and should not be construed as being limited to the embodiments set forth herein.

It should be understood that various steps recited in the method embodiments of the present disclosure can be executed in a different order, and/or executed in parallel. In addition, the method implementations may include additional steps and/or omit to perform illustrated steps. The scope of the present disclosure is not limited in this respect. Unless specifically stated otherwise, the relative arrangement of components and steps, numerical expressions, and numerical values set forth in these embodiments should be interpreted as merely exemplary and do not limit the scope of the present disclosure.

The term “comprising” and its variations used in the present disclosure means an open term that comprises at least the following elements/features but does not exclude other elements/features, that is, “comprising but not limited to”. In addition, the term “including” and its variations used in the present disclosure means an open term that includes at least the following elements/features but does not exclude other elements/features, that is, “including but not limited to”. Therefore, comprising and including are synonymous. The term “based on” means “based at least in part on.”

The term “one embodiment”, “some embodiments” or “an embodiment” throughout the specification means that a particular feature, structure, or characteristic described in combination with the embodiment is included in at least one embodiment of the present disclosure. For example, the term “one embodiment” denotes “at least one embodiment”; the term “another embodiment” means “at least one additional embodiment”; the term “some embodiments” means “at least some embodiments.” Moreover, the appearances of the phrases “in one embodiment”, “in some embodiments” or “in an embodiment” in various places throughout the specification do not necessarily all refer to the same embodiment, but may also refer to the same embodiment.

It should be noted that the concepts of “first” and “second” etc. mentioned in the present disclosure are only used to distinguish between different apparatus, modules or units, and are not used to limit the order of functions performed by these apparatus, modules or units or their interdependence. Unless otherwise specified, the concepts of “first”, “second” etc. are not intended to imply that objects so described must be in a given order in time, space, ranking, or any other manner.

It should be noted that modifiers of “one” and “a plurality of” mentioned in the present disclosure are illustrative and not restrictive, and those skilled in the art should understand that they should be construed as “one or more” unless the context clearly indicates otherwise.

The names of messages or information interacted between a plurality of apparatus in the embodiments of the present disclosure are only used for illustration, and are not used to limit the scope of these messages or information.

The embodiments of the present disclosure will be described in detail below with reference to the accompanying drawings, but the present disclosure is not limited to these specific embodiments. The following specific embodiments can be combined with each other, and the same or similar concepts or processes may not be repeated in some embodiments. In addition, in one or more embodiments, specific features, structures, or characteristics may be combined in any suitable manner that will be clear from the present disclosure by a person of ordinary skill in the art.

It should be understood that the present disclosure also does not have any limitation on how to obtain the image to be applied/processed. In one embodiment of the present disclosure, it may be acquired from a storage apparatus, such as an internal memory or an external storage apparatus. In another embodiment of the present disclosure, it can be photographed by using a photographing component. It should be noted that the acquired image may be a captured image, or may be a frame image in a captured video, and is not particularly limited to thereto.

In the context of the present disclosure, an image may refer to any of a variety of images, such as a color image, a grayscale image, and so on. It should be noted that in the context of this specification, the type of an image is not specifically limited. In addition, the image may be any suitable image, such as a raw image obtained by a camera apparatus, or an image that has been subjected to specific processing on raw image, such as preliminary filtering, anti-aliasing, color adjustment, contrast adjustment, normalization, and so on. It should be noted that pre-processing operations may also include other types of pre-processing operations known in the art, which will not be described in detail here.

In view of the problems in the related art that developing a model for each attribute, the number of models is too large, the storage space is large, and the amount of calculation to obtain all attributes is also large, the idea of using multi-task classification is proposed. For multiple attribute classification tasks, a shared feature extraction network is adopted, and in the final classifier part, multiple classifiers are simultaneously taken out to perform classification tasks for multiple attributes. With the shared feature extraction network, the number of models and the amount of calculation can be effectively reduced, but this method of using the way of shared feature extraction network causes the network to focus on global feature information, and cannot give corresponding features for attributes of different areas. For the task of face attribute classification, obtaining features of attributes of corresponding areas and preventing the interference of features of other attributes has a significant influence on the final classification accuracy.

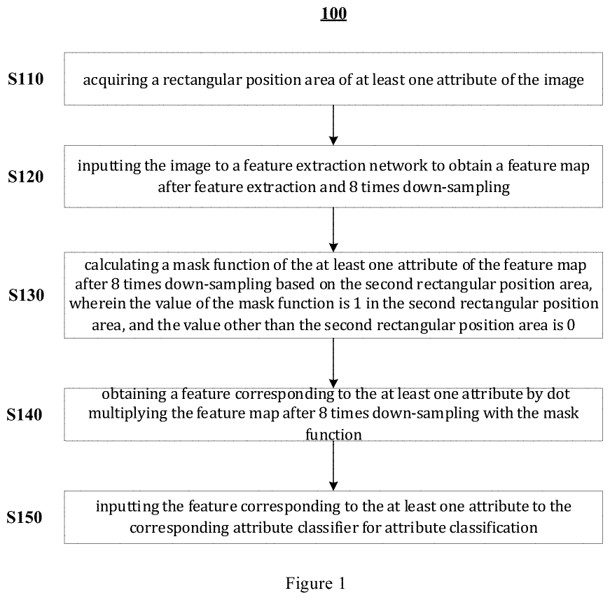

In order to implement the multiple attributes classification task for an image (for example, a face image) with a small number of models, and at the same time prevent features of other attributes from interfering with current classification attribute, the present disclosure proposes an image attribute classification method based on area selection. The detailed description is given below with reference to FIGS. 1-3.

FIG. 1 shows an image attribute classification method 100 based on area selection according to some embodiments of the present disclosure.

As shown in FIG. 1, at step S110, a rectangular position area of at least one attribute of an image is acquired.

Herein, a face image is mainly taken as an example to illustrate. First, landmarks of a face are acquired through a face landmark model, usually 106 or 96 landmarks, and the landmarks are distributed in a plurality of areas such as eyes, eyebrows, nose, mouth, face, etc., the corresponding attribute area in the input face image can be quickly obtained according to the landmarks acquired.

According to some embodiments of the present disclosure, the at least one attribute here can be one or more attributes of eye shape, eyebrow shape, nose shape, mouth shape, face type, hairstyle, the beard type, and accessories wearing condition, etc.

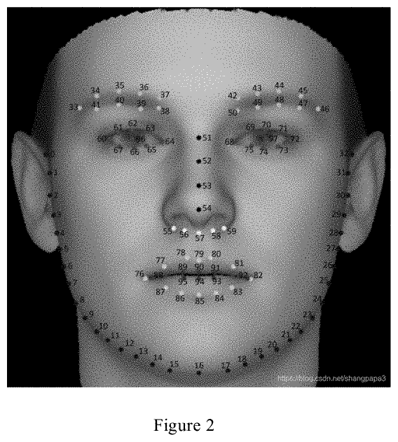

FIG. 2 shows a schematic diagram of 96 landmarks of a human face according to some embodiments of the present disclosure. On the 96 landmarks in a face, if the mouth area of an input face image is intent to be obtained, that is, the at least one attribute is the mouth attribute, the rectangular position area of the mouth can be determined using several landmarks at the outmost boundary. As shown in FIG. 2, five landmarks 78, 80, 76, 82, 85 can be used to obtain the mouth area in the image:

x1=landmarks(76)·x

x2=landmarks(82)·x

y1=min(landmarks(78)·y,landmarks(80)·y)

y2=landmarks(85)·y

bbox=[x1,y1,x2,y2]

Wherein, landmarks are position coordinates of the obtained landmarks of the face, and bbox is the position coordinate of the detection box of the acquired face attribute. Here, coordinates of the upper left corner of the rectangular box of the mouth area are (x1, y1), and coordinates of the lower right corner are (x2, y2), and the area represented by bbox is the rectangular position area of the at least one attribute.

The bbox coordinates obtained here can be used in subsequent operations to intercept the mouth area in the raw image input and the corresponding network down-sampled feature map. Rectangular position areas of other face attributes are acquired in a similar way as the mouth, which are obtained by selecting landmarks of theirs upper, lower, left, and right borders.

As shown in FIG. 1, at S120, the image is input to a feature extraction network to obtain a feature map after feature extraction and N times down-sampling.

The feature extraction network can be a common convolutional neural network, or it can be a feature extraction network built by own for a specific task. The following takes a convolutional neural network as an example for description, the size of an image input in a convolutional neural network is usually 224*224.

According to an exemplary embodiment of the present disclosure, an image with a double linear interpolation value of [224,224] is input to a convolutional neural network, and feature extraction is performed through a convolutional layer of the convolutional neural network, and the feature extracted image is down-sampled N times through a cellularization layer of the convolutional neural network, thus obtaining a feature map F after feature extraction and N times down-sampling.

It should be understood that boundary coordinates (i.e., the upper left corner coordinates and the lower right corner coordinates) of the position area occupied by the at least one attribute in the feature map F after N times down-sampling are 1/N of the boundary coordinates of the position area occupied in the raw image. In order to distinguish, the position occupied by the at least one attribute in the feature map after N times down-sampling is referred to as a second rectangular position area.

The present disclosure is explained by taking a face image as an example, because face attribute classification focuses on differences more detail, too big down-sampling factor would extract even more abstract advanced features, resulting in loss of detailed information, therefore, in some embodiments the down-sampling factor N is 4 or 8, here, taking N=8 as an example for explanation. The size of the feature map after feature extraction and 8 times down-sampling is [B,28,28,C], where B is the batch size, that is, the number of images input each time when a convolutional neural network is trained, and C is the number of channels in the convolutional neural network.

As shown in FIG. 1, at step S130, based on the second rectangular position area, a mask function of the at least one attribute of the feature map after N times down-sampling is calculated, wherein the value of the mask function is 1 in the second rectangular position area, and the value other than the second rectangular position area is 0.

Also take the mouth attribute classification as an example, as mentioned above, the rectangular position area of the mouth attribute in the raw image has been obtained to be [x1, y1, x2, y2], therefore, the mouth attribute area on the feature map after down-sampling 8 times can be obtained to be [x1//8, y1//8, x2//8, y2//8], wherein “II” means to take integer for divided data. Keep the value of the mouth attribute area on the corresponding feature map, and set values outside this area to 0. This process is implemented by matrix dot multiplication. First, the mask function corresponding to the mouth attribute is obtained:

mask=zeros(B,28,28,C)

mask[B,y1//8:y2//8,x1//8:x2//8,C]=1.

Wherein, what mask=zeros(B, 28, 28, C) expressed is to initialize a tensor size of all zeros with the size (B, 28, 28, C), and what mask[B, y1//8: y2//8, x1//8: x2//8, C]=1 expressed is the area corresponding to the mouth attribute is 1.

As shown in FIG. 1, at step S140, obtaining a feature corresponding to the at least one attribute by dot multiplying the feature map after N times down-sampling with the mask function.

Also take the mouth attribute classification as an example, the feature of corresponding mouth attribute (area with a mask of 1) is retained through Fₘₐₛₖ=F*mask dot multiplication operation, and areas outside this attribute are set to 0, so as to obtain a feature corresponding to the mouth attribute. After these features subjected to mask for area selection, it can effectively reduce interferences of other face areas (for example, the nose area) on the target attribute mouth, and obtain more accurate feature information.

Masks of other attributes and corresponding area selection features are obtained by using this method as well, so far, area selection features corresponding to multiple attributes respectively can be obtained.

As shown in FIG. 1, at step S150, the obtained feature corresponding to the at least one attribute is input to the corresponding attribute classifier for attribute classification.

Also take the mouth attribute classification as an example, the obtained features corresponding to the mouth attributes are input into the mouth attribute classifier for mouth attribute classification, for example, for mouth shape classification or lip color classification.

Still take the convolutional neural network as the feature extraction network as an example, after obtaining area features of multiple attributes, an attribute classifier is implemented by splicing several convolutional layers and a full connecting layer after the obtained feature maps of each attribute, and classification and prediction can be done for each attribute feature separately.

This method can use a convolutional neural network to solve multiple attribute classification problems at the same time without training a model for each attribute, meanwhile, it can effectively prevent other attributes from interfering with current attributes, thereby solving the problem of mutual interference between attributes caused by using a common feature selector in the related art, enabling the final classifier to focus on features of corresponding area for classification.

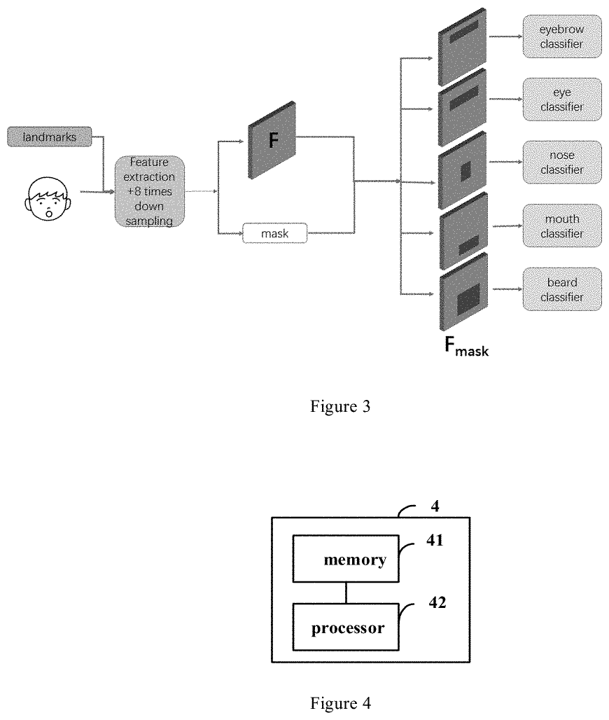

FIG. 3 shows an exemplary block diagram of face attribute classification based on area selection according to an exemplary embodiment of the present disclosure. Here, taking a convolutional neural network as a feature extraction network as an example, and assuming that the down-sampling factor is 8.

As shown in FIG. 3, inputting the face image with double linear interpolation value [224,224] and the obtained face landmark position coordinates to a convolutional neural network for feature extraction, and conducting 8 times down-sampling to the extracted feature map, thus obtaining a down-sampled full-face feature map F with the size of [B,28,28,C].

Also, taking mouth attribute classification as an example, assuming that the rectangular position area of the mouth attribute in the raw image that has been obtained as described above is [x1, y1, x2, y2], the mouth attribute area on the feature map after 8 times down-sampling by the convolutional neural network is [x1//8, y1//8, x2//8, y2//8]. Therefore, the area where the mask of the mouth area can be obtained is [x1//8, y1//8, x2//8, y2//8]. According to above definition for mask, the value of the area [x1//8, y1//8, x2//8, y2//8] is retained, while values outside this area is set to 0. In the same way, the mask for each attribute of the face can be obtained.

The feature map Fₘₐₛₖ=F*Mask for each attribute is obtained by matrix dot multiplication of the full-face feature map F with the mask for each attribute of the face. As shown in FIG. 3, Fₘₐₛₖ is the feature maps of eyebrows, eyes, nose, mouth, and beard from top to bottom and in that order, since the mask shields interferences from other features on current features, the obtained feature maps for respective attributes are very clean.

Then, the obtained feature maps for respective attributes are input into corresponding attribute classifiers for attribute classifications.

The image (for example, face) attribute classification method based on area selection proposed in the present disclosure can reduce influences from other area features on the attribute classification by performing area selection on full image features and acquiring area features corresponding to attributes to be classified, thereby obtaining better classification accuracy.

Some embodiments of the present disclosure also provide an electronic device. FIG. 4 shows a block diagram of some embodiments of the electronic device 4 of the present disclosure. The electronic device can be used to implement the method according to any embodiment of the present disclosure.

For example, in some embodiments, the electronic device 4 may be a device of various types, for example, but not limited to a mobile terminal such as a mobile phone, a notebook, a digital broadcast receiver, a PDA (Personal Digital Assistant), a PAD (tablet), a PMP (Portable Multimedia Player), a vehicle-mounted terminal (for example, a vehicle-mounted navigation terminal), etc., and a fixed terminal such as a digital TV, a desktop computer, etc. For example, the electronic device 4 may include a display panel for displaying data and/or execution results used in the solution according to the present disclosure. For example, the display panel may have various shapes, for example, a rectangular panel, an oval panel, or a polygonal panel, etc. In addition, the display panel can be not only a flat panel, but also a curved panel, or even a spherical panel.

As shown in FIG. 4, the electronic device 4 of this embodiment includes: a memory 41 and a processor 42 coupled to the memory 41. It should be noted that components of the electronic device 4 shown in FIG. 4 are only exemplary and not restrictive. According to actual application requirements, the electronic device 4 may also have other components. The processor 42 can control other components in the electronic device 4 to perform desired functions.

In some embodiments, the memory 41 is used to store one or more computer-readable instructions. When the processor 42 is used to run computer-readable instructions, the computer-readable instructions are executed by the processor 42 to implement the method according to any of the foregoing embodiments. The specific implementation of each step of the method and related explanation content can refer to above-mentioned embodiments, and duplicated parts will not be repeated here.

For example, the processor 42 and the memory 41 may directly or indirectly communicate with each other. For example, the processor 42 and the memory 41 may communicate through a network. The network may include a wireless network, a wired network, and/or any combination of a wireless network and a wired network. The processor 42 and the memory 41 may also communicate with each other via a system bus, which is not limited in the present disclosure.

For example, the processor 42 may be embodied as various appropriate processors, processing devices, etc., such as a Central Processing Unit (CPU), a Graphics Processing Unit (GPU), a Network Processor (NP), etc.; it may also be a Digital Signal Processor (DSP), an Application Specific Integrated Circuit (ASIC), a Field Programmable Gate Array (FPGA) or other programmable logic device, discrete gate or transistor logic device, discrete hardware component. The central processing unit (CPU) can be an X86 or ARM architecture. For example, the memory 41 may include any combination of various forms of computer-readable storage media, for example, volatile memory and/or non-volatile memory. The memory 41 may include, for example, a system memory, and the system memory, for example, stores an operating system, an application program, a Boot Loader, a database, and other programs. Various application programs and various data can also be stored in storage medium.

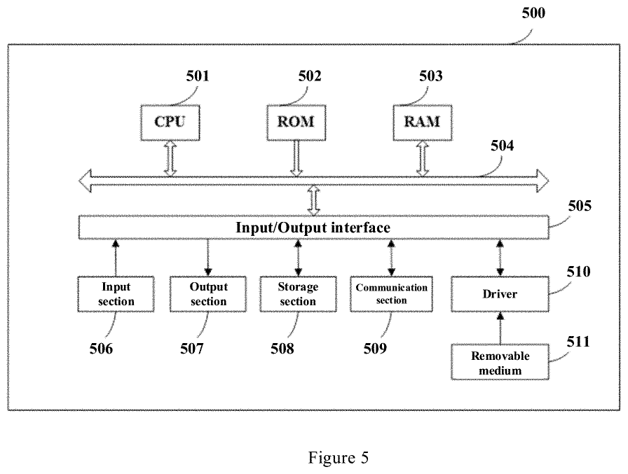

In addition, according to some embodiments of the present disclosure, various operations/processing according to the present disclosure, when implemented by software and/or firmware, can install a program constituting the software from a storage medium or a network to a computer system with a dedicated hardware structure, such as the computer system 500 shown in FIG. 5, which, when having various programs installed thereon, can perform various functions, including functions described above. FIG. 5 shows a block diagram of an example structure of a computer system that can be adopted in some embodiments of the present disclosure.

In FIG. 5, a central processing unit (CPU) 501 performs various processing in accordance with a program stored in a read-only memory (ROM) 502 or a program loaded from a storage section 508 to a random-access memory (RAM) 503. In the RAM 503, data required when the CPU 501 executes various processing and the like is also stored as necessary. The central processing unit is only exemplary, and it may also be other types of processors, such as the various processors described above. The ROM 502, the RAM 503, and the storage section 508 may be various forms of computer-readable storage media, as described below. It should be noted that although the ROM 502, the RAM 503, and the storage apparatus 508 are respectively shown in FIG. 5, one or more of them may be combined or located in the same or different memory or storage modules.

The CPU 501, the ROM 502, and the RAM 503 are connected to each other via a bus 504. The input/output interface 505 is also connected to the bus 504.

The following components are connected to the input/output interface 505: the input section 506, such as a touch screen, a touch panel, a keyboard, a mouse, an image sensor, a microphone, an accelerometer, a gyroscope, etc.; the output section 507, including a display, such as a cathode ray tube (CRT), a liquid crystal display (LCD), a speaker, a vibrator, etc.; storage section 508, including a hard disk, a tape, etc.; and communication section 509, including a network interface card such as a LAN card, a modem, etc. The communication section 509 allows communication processing to be performed via a network such as the Internet. It can be understood that although various apparatus or modules in the computer system 500 shown in FIG. 5 communicate via the bus 504, they may also communicate via a network or other means, where the network may include a wireless network, a wired network, and/or any combination of wireless network and wired network.

The driver 510 is also connected to the input/output interface 505 as needed. A removable medium 511 such as a magnetic disk, an optical disk, a magneto-optical disk, a semiconductor memory, etc. is mounted on the drive 510 as needed, so that the computer program read out therefrom is installed into the storage section 508 as needed.

In the case that above-mentioned series of processing is implemented by software, the program constituting the software can be installed from a network such as the Internet or a storage medium such as a removable medium 511.

According to some embodiments of the present disclosure, the process described above with reference to the flowchart can be implemented as a computer software program. For example, some embodiments of the present disclosure includes a computer program product, which includes a computer program carried on a computer-readable medium, and the computer program contains program code for executing the method shown in the flowchart. In such some embodiments, the computer program may be downloaded and installed from the network through the communication apparatus 509, or installed from the storage apparatus 508, or installed from the ROM 502. When the computer program is executed by the CPU 501, the above-mentioned functions defined in the methods of the embodiments of the present disclosure are executed.

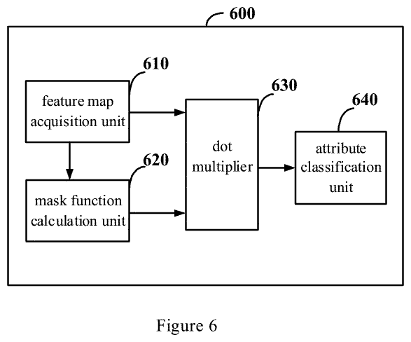

FIG. 6 is a schematic structural diagram of an image attribute classification apparatus 600 according to some embodiments of the present disclosure. Such image attribute classification apparatus 600 can be implemented by a dedicated hardware-based system that performs the specified functions or operations as described in the present application, or it can be implemented by a combination of dedicated hardware and computer instructions.

As shown in FIG. 6, the image attribute classification apparatus 600 includes a feature map acquisition unit 610, a mask function calculation unit 620, a dot multiplier 630 and an attribute classification unit 640.

The feature map acquisition unit 610 is configured to input the image as described above to a feature extraction network to obtain a feature map after feature extraction and N times down-sampling, wherein at least one attribute of the image occupies a second rectangular position area in the feature map after N times down-sampling.

The mask function calculation unit 620 is configured to calculate a mask function of the at least one attribute of the feature map after N times down-sampling based on the second rectangular position area.

The dot multiplier 630 is configured to obtain a feature corresponding to the at least one attribute by dot multiplying the feature map after N times down-sampling with the mask function.

The attribute classification unit 640 is configured to input the feature corresponding to the at least one attribute to the corresponding attribute classifier for attribute classification.

It should be noted that in the context of the present disclosure, a computer-readable medium may be a tangible medium, which may contain or store a program for using by an instruction execution system, apparatus, or device or for using in combination with the instruction execution system, apparatus, or device. The computer-readable medium may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program, and the program may be used by or in combination with an instruction execution system, apparatus, or device. In the present disclosure, a computer-readable signal medium may include a data signal propagated in a baseband or as a part of a carrier wave, in which a computer-readable program code is carried. This propagated data signal can take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program for use by or in combination with the instruction execution system, apparatus, or device. The program code contained on the computer-readable medium can be transmitted by any suitable medium, including but not limited to: wire, optical cable, RF (Radio Frequency), etc., or any suitable combination thereof.

The aforementioned computer-readable medium may be included in aforementioned electronic devices; or it may exist alone without being assembled into the electronic device.

In some embodiments, there is also provided a computer program, comprising: instructions, which, when executed by a processor, cause the processor to execute the methods of any of the foregoing embodiments. For example, the instruction may be embodied as computer program code.

In the embodiments of the present disclosure, the computer program code for performing the operations of the present disclosure can be written in one or more programming languages or a combination thereof. The aforementioned programming languages include but are not limited to object-oriented programming languages such as Java, Smalltalk, C++, and include conventional procedural programming languages such as “C” language or similar programming languages. The program code can be executed entirely on a user's computer, partly executed on a user's computer, executed as an independent software package, partly executed on a user's computer and partly executed on a remote computer, or entirely executed on a remote computer or server. In the case of involving a remote computer, the remote computer can be connected to a user's computer through any kind of network (including a local area network (LAN) or a wide area network (WAN)), or it can be connected to an external computer (for example, connected by using Internet provided by an Internet service provider).

The flowcharts and block diagrams in the accompanying drawings illustrate possible architecture, function, and operation implementations of a system, method, and computer program product according to various embodiments of the present disclosure. In this regard, each block in a flowchart or block diagram may represent a module, program segment, or part of code, which contains one or more executable instructions for realizing specified logic functions. It should also be noted that, in some alternative implementations, functions marked in a block may also occur in a different order than the order marked in the drawings. For example, two blocks shown in succession can actually be executed substantially in parallel, and they can sometimes be executed in the reverse order, depending on functions involved. It should also be noted that each block in a block diagram and/or flowchart, and the combination of blocks in a block diagram and/or flowchart, can be implemented by a dedicated hardware-based system that performs the specified functions or operations, or it can be implemented by a combination of dedicated hardware and computer instructions.

The modules, components, or units involved in the embodiments of the present disclosure can be implemented in software or hardware. Wherein, names of the modules, components or units do not constitute a limitation on the modules, components or units themselves under certain circumstances.

The functions described hereinabove may be performed at least in part by one or more hardware logic components. For example, without limitation, exemplary hardware logic components that can be used include: Field Programmable Gate Array (FPGA), Application Specific Integrated Circuit (ASIC), Application Specific Standard Product (ASSP), System on Chip (SOC), Complex Programmable Logical Device (CPLD) and so on.

According to some embodiments of the present disclosure, there is provided an image attribute classification method, comprising: inputting the image to a feature extraction network to obtain a feature map after feature extraction and N times down-sampling, wherein at least one attribute of the image occupies a second rectangular position area in the feature map after N times down-sampling; based on the second rectangular position area, calculating a mask function of the at least one attribute of the feature map after N times down-sampling; obtaining a feature corresponding to the at least one attribute by dot multiplying the feature map after N times down-sampling with the mask function; and inputting the obtained feature corresponding to the at least one attribute to the corresponding attribute classifier for attribute classification.

According to some embodiments of the present disclosure, the method further comprising a step of acquiring a first rectangular position area of at least one attribute of the image before inputting the image into the feature extraction network.

According to some embodiments of the present disclosure, the value of the mask function is 1 in the second rectangular position area, and the value other than the second rectangular position area is 0.

According to some embodiments of the present disclosure, the upper left corner coordinates and the lower right corner coordinates of the second rectangular position area are 1/N of the upper left corner coordinates and the lower right corner coordinates of the first rectangular position area, respectively.

According to some embodiments of the present disclosure, acquiring the first rectangular position area of the at least one attribute of the image comprises: acquiring position coordinates of landmarks of the at least one attribute of the image; and acquiring the first rectangular position area of the at least one attribute using position coordinates of several landmarks at the outmost boundary of the at least one attribute.

According to some embodiments of the present disclosure, the image is a face image, and the at least one attribute is selected from eyes, eyebrows, nose, mouth, face type, hairstyle, the beard, and jewelry wearing condition.

According to some embodiments of the present disclosure, the corresponding attribute classifier includes an eye classifier, an eyebrow classifier, a nose classifier, a mouth classifier, a face type classifier, a hairstyle classifier, a beard classifier, and a jewelry wearing condition classifier.

According to some embodiments of the present disclosure, N is 4 or 8.

According to some embodiments of the present disclosure, the feature extraction network is a first convolutional neural network.

According to some embodiments of the present disclosure, the feature extraction is implemented by a convolutional layer of the first convolutional neural network, and the down-sampling is implemented by a cellularization layer of the first convolutional neural network.

According to some embodiments of the present disclosure, the corresponding attribute classifier is implemented by a convolutional layer and a full connecting layer of a second convolutional neural network.

According to some embodiments of the present disclosure, a double linear interpolation size of the image is [224,224].

According to some embodiments of the present disclosure, there is provided an image attribute classification apparatus, comprising: a feature map acquisition unit configured to input the image to a feature extraction network to obtain a feature map after feature extraction and N times down-sampling, wherein at least one attribute of the image occupies a second rectangular position area in the feature map after N times down-sampling; a mask function calculation unit configured to, based on the second rectangular position area, calculate a mask function of the at least one attribute of the feature map after N times down-sampling; a dot multiplier configured to obtain a feature corresponding to the at least one attribute by dot multiplying the feature map after N times down-sampling with the mask function; and an attribute classification unit configured to input the obtained feature corresponding to the at least one attribute to the corresponding attribute classifier for attribute classification.

According to some embodiments of the present disclosure, there is provided an electronic device, comprising: a memory; and a processor coupled to the memory, the memory having instructions stored therein, which, when executed by the processor, causes the electronic device to execute the method of any embodiment in the present disclosure.

According to some embodiments of the present disclosure, there is provided a computer-readable storage medium having computer programs stored thereon, which, when executed by a processor, executes the method of any embodiment in the present disclosure.

According to some embodiments of the present disclosure, there is provided a computer program product including computer programs, which, when executed by a processor, executes the method of any embodiment in the present disclosure.

The above description is only some embodiments of the present disclosure and an explanation to the technical principles applied. Those skilled in the art should understand that the scope of disclosure involved in this disclosure is not limited to technical solutions formed by specific combination of above technical features, and should also cover other technical solutions formed by arbitrarily combining above technical features or equivalent features thereof without departing from above disclosed concept. For example, those technical solutions formed by exchanging of above features and technical features disclosed in the present disclosure (but not limited to) having similar functions with each other.

In the description provided herein, many specific details are set forth. However, it is understood that the embodiments of the present disclosure can be implemented without these specific details. In other cases, in order not to obscure understanding of the description, well-known methods, structures and technologies are not shown in detail.

In addition, although various operations are depicted in a specific order, this should not be understood as requiring these operations to be performed in the specific order shown or performed in a sequential order. Under certain circumstances, multitasking and parallel processing may be advantageous. Likewise, although several specific implementation details are included in above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although some specific embodiments of the present disclosure have been described in detail through examples, those skilled in the art should understand that the above examples are only for illustration and not for limiting the scope of the present disclosure. Those skilled in the art should understand that the above embodiments can be modified without departing from the scope and spirit of the present disclosure. The scope of the present disclosure is defined by the appended claims.

What is claimed is:

1. An image attribute classification method, including:
inputting the image to a feature extraction network to obtain a feature map after feature extraction and N times down-sampling, wherein at least one attribute of the image occupies a second rectangular position area in the feature map after N times down-sampling;
calculating a mask function of the at least one attribute of the feature map after N times down-sampling based on the second rectangular position area;
obtaining a feature corresponding to the at least one attribute by dot multiplying the feature map after N times down-sampling with the mask function; and
inputting the feature corresponding to the at least one attribute to a corresponding attribute classifier for attribute classification.

2. The image attribute classification method of claim 1, further including a step of acquiring a first rectangular position area of at least one attribute of the image before inputting the image to the feature extraction network.

3. The image attribute classification method of claim 2, wherein the acquiring a first rectangular position area of at least one attribute of the image comprises:
acquiring the position coordinates of key points of the at least one attribute of the image; and
acquiring the first rectangular position area of at least one attribute using the position coordinates of several key points of the most boundary of the at least one attribute.

4. The image attribute method of claim 3, wherein a value of the mask function is 1 in the second rectangular position area, and the value other than the second rectangular position area is 0.

5. The image attribute method of claim 4, wherein left upper corner coordinates and lower right corner coordinates of the second rectangular position area are 1/N of the left upper left corner coordinates and the lower right corner coordinates of the first rectangular position area respectively.

6. The image attribute classification method of claim 1, wherein the image is a face image, and wherein the at least one attribute is from eyes, eyebrows, nose, mouth, face type, hairstyle, the beard and a jewelry wearing situation.

7. The image attribute classification method of claim 6, wherein the corresponding attribute classifier comprises an eye classifier, an eyebrow classifier, a nose classifier, a mouth classifier, a face type classifier, a hairstyle classifier, a beard classifier and jewelry wearing condition classifier.

8. The image attribute classification method of claim 6, wherein N is 4 or 8.

9. The image attribute classification method of claim 1, wherein the feature extraction network is a first convolutional neural network.

10. The image attribute classification method of claim 9, wherein the feature extraction is implemented by a convolution layer of the first convolutional neural network, and the down sampling is implemented by a cellularization layer of the first convolutional neural network.

11. The image attribute classification method of claim 9, wherein the corresponding attribute classifier is implemented by a convolution layer and a full connecting layer of a second convolutional neural network.

12. The image attribute classification method of claim 9, wherein a double linear interpolation size of the image is [224, 224].

13. An image attribute classification apparatus, including:
a feature map acquisition unit configured to input the image to a feature extraction network to obtain a feature map after feature extraction and N times down-sampling, wherein at least one attribute of the image occupies a second rectangular position area in the feature map after N times down-sampling;
a mask function calculation unit configured to calculate a mask function of the at least one attribute of the feature map after N times down-sampling based on the second rectangular position area;
a dot multiplier configured to obtain a feature corresponding to the at least one attribute by dot multiplying the feature map after N times down-sampling with the mask function; and
an attribute classification unit configured to input the feature corresponding to the at least one attribute to the corresponding attribute classifier for attribute classification.

14. An electronic device, including:
a memory; and
a processor coupled to the memory that stores instructions, when executed by the processor, the instructions cause the electronic device to perform the method of claim 1.

15. A non-transitory computer readable storage medium having computer programs stored thereon, when executed by the processor, the computer programs perform the method of claim 1.

16. A computer program product comprising computer programs, which when executed by a processor, causes the computer programs to perform the method of claim 1.
